(19) United States
(12) Patent Application Publication
(10) Pub. No.: US 2014/0047766 A1
(43) Pub. Date: Feb. 20, 2014

(54) CONTROLLED ON-DEMAND IRRIGATION SYSTEM

(71) Applicant: Valmont Industries, Inc., Omaha, NE (US)

(72) Inventors: Jacob L. LaRue, Omaha, NE (US); Craig S. Malsam, Omaha, NE (US)

(73) Assignee: Valmont Industries, Inc., Omaha, NE (US)

(21) Appl. No.: 13/967,544

(22) Filed: Aug. 15, 2013

Related U.S. Application Data
(60) Provisional application No. 61/683,797, filed on Aug. 16, 2012.
(60) Provisional application No. 61/815,875, filed on Apr. 25, 2013.
(60) Provisional application No. 61/846,317, filed on Jul. 15, 2013.

(51) Int. Cl. A01G 29/00

(52) U.S. Cl. CPC A01G 29/00
USPC 47/48.5

(57) ABSTRACT

The present disclosure is directed to a controlled on-demand irrigation system. In an implementation, the on-demand irrigation system includes a control device configured to control supply of an aqueous solution and semi-porous supply lines. The semi-porous supply lines have a porosity characteristic configured to be altered when acted upon by a surfactant root exudates to permit a flow of the aqueous solution therethrough. The control device is configured to cause injection of the aqueous solution upon a determination that an amount of aqueous solution within the semi-porous supply lines is below an aqueous solution threshold.

### BACKGROUND

Drip irrigation, also known as trickle irrigation, micro-irrigation, or localized irrigation, is a method that conserves water and fertilizer (e.g., application) by allowing water to drip slowly to the roots of plants through a network of valves, pipes, and/or emitters.

### SUMMARY

The present disclosure is directed to a controlled on-demand irrigation system. In an implementation, the on-demand irrigation system includes a control device configured to control supply of an aqueous solution and semi-porous supply lines. The semi-porous supply lines have a porosity characteristic configured to be altered when acted upon by a surfactant root exudates to permit a flow of the aqueous solution therethrough. The control device is configured to cause injection of the aqueous solution upon a determination that an amount of aqueous solution within the semi-porous supply lines is below an aqueous solution threshold.

### BRIEF DESCRIPTION OF THE DRAWING

FIG. 1 illustrates a sub-surface irrigation system for supplying applicant (e.g., water and/or nutrients) to plant roots in accordance with an example implementation of the present disclosure.

FIG. 2 illustrates a sub-surface irrigation system for supplying applicant to plant roots in accordance with another example implementation of the present disclosure.

FIG. 3 illustrates a block diagram of a control device that is communicatively coupled (e.g., a wired communication, a wireless communication) to fluid displacement devices, an injection fluid displacement device, and/or a soil moisture and control device of the sub-surface irrigation system shown in FIGS. 1 and 2 in accordance with an example implementation of the present disclosure.

### DETAILED DESCRIPTION

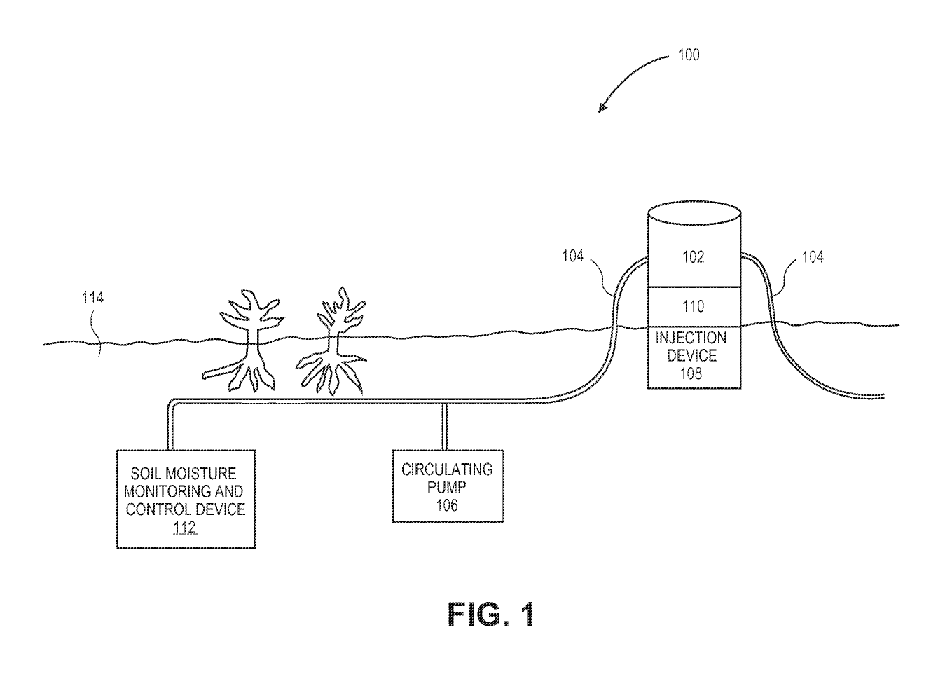

FIG. 1 illustrates an on-demand irrigation system 100 in accordance with an example implementation of the present disclosure. The irrigation system 100 is configured to supply an applicant (e.g., an aqueous solution), such as a mixture of water and/or nutrients, or the like, to vegetation (e.g., plants) as required (e.g., on-demand) by the respective vegetation. For example, the vegetation may exude a surfactant that causes the irrigation system 100 to release the applicant to the vegetation on-demand or the release may be controlled by the operator through a control device, which is described in greater detail below.

As shown, in an implementation, the irrigation system 100 may include a reservoir 102 configured to store (e.g., hold) and control the supply of an applicant to be furnished to the vegetation over a period of time. In another implementation, the supply may be controlled by way of a controlled pump device. The reservoir 102 is in fluid communication with (e.g., connected to) a plurality of supply lines 104 (e.g., tubes, tubing, etc.). It is contemplated that the supply lines 104 may be of any suitable shape, such as in a network configuration (e.g., layout), to allow the transportation and/or disbursement of the applicant. The supply lines 104 are configured to be at least partially underground and proximate to the growing vegetation (e.g., supply lines 104 extend below the surface of a support medium to feed a plurality of plants). In some implementations, the supply lines 104 are configured to be at least substantially underground to furnish applicant to the roots of the vegetation. It is understood that the supply lines 104 may be positioned underground prior to vegetation germination. In some implementations, the supply lines 204 may be positions underground after vegetation germination. Thus, the supply lines 104 may be positioned underground during the life cycle of the vegetation. In some implementations, the reservoir 102 is elevated off the ground (e.g., a medium where the vegetation is permitted to grow) in order to create a low water pressure (e.g., pound per square inch (psi) value). For instance, the reservoir 102 is in an elevated position as compared to the supply lines 104, which creates a low water pressure (e.g., less than or equal to eight (8) psi). Thus, the irrigation system 100 can operate at a low pressure while sufficient furnishing an applicant to the vegetation.

In a specific implementation, the supply lines 104 may comprised of a suitable semi-porous or porous polyethylene material, which is configured to allow holding of the water until the surface tension is broken either by root exudates or operator control and then the passage of water. However, it is understood that the supply lines 104 may be comprised of various other materials that are configured to selectively allow the passage of water as described in greater detail herein. For example, the supply lines 104 may be comprised of an at least partially porous material in certain situations, as described in greater detail below. In another specific implementation, the supply lines 104 may comprise a cylindrical supply line having a radius ranging from at least approximately fifteen millimeters to at least approximately thirty-five millimeters (15 mm to 35 mm). However it is contemplated that the supply lines may be cylindrical tubes having a greater radius to provide a greater surface area for which to supply the applicants to the vegetation.

The supply lines 104 can serve to function as a source of applicant for the vegetation. For instance, the supply lines 104 are configured to inhibit the flow of water when the vegetation does not require the applicant and are configured to at least partially allow the flow of applicant to the roots of a plant when the vegetation requires the applicant. For example, a plant's capillary force may be utilized to draw solution from the supply tubes 104. The plant root may exude a surfactant that at least partially breaks the surface tension of the water at the surface of the supply line 104 to become at least partially porous (e.g., polyethylene material becomes at least partially porous when an exudate is released from the plant root) when the plant requires the applicant. More specifically, a portion of a wall defining the respective supply line 104 may be modified to become porous in response to an exudate exuded by a plant (i.e., a porosity characteristic of the supply line 104 is modified in response to a surfactant exudation event acting upon the supply line 104). In other words, the irrigation system 100 is configured to release an applicant to the respective plant on-demand (e.g., when the plant requires the applicant). In another example, the plant root may be in contact with a supply line 104 and cause a “negative pressure” effect to cause the release of the applicant from the supply line 104 to the root. Plants and their roots are capable of exerting a negative pressure to extract water from the plant's surroundings. In another example, the supply line 104 may be forced to break surface tension by the application of a pressure greater than the hydro head of the porous tube.

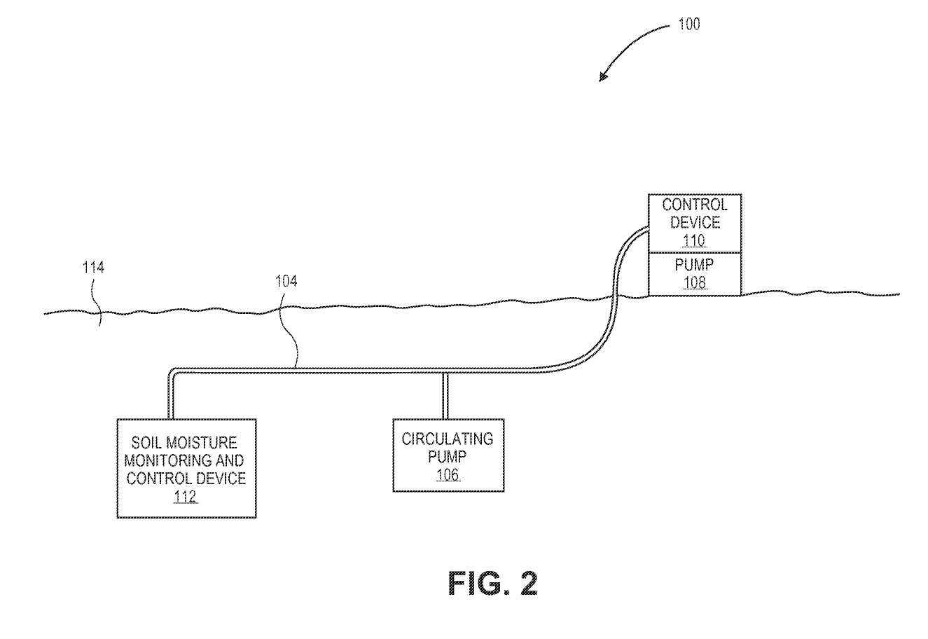

As shown in FIG. 1, the irrigation system 100 also includes one or more fluid displacement devices 106 that are connected to the supply lines 104 (operatively connected to the control device 110). In an implementation, the fluid displacement devices 106 are controlled pump devices that are configured to circulate the applicant allowing for a more uniform applicant throughout a larger irrigation system 100. The fluid displacement devices 106 may also be utilized to reduce the elevation of the reservoir 102. In another implementation, the fluid displacement devices 106 may be utilized to replace the reservoir 102 (see FIG. 2). In this implementation, the fluid displacement devices 106 may be in fluid communication with a fluid supply device. For example, the fluid displacement devices 106 may be utilized to create (generate) low water pressure throughout the system 100 such that the reservoir 102 does not need to be elevated to create the water pressure.

The system 100 also includes an injection fluid displacement device 108 (e.g., injection pump device). The injection fluid displacement device 108 is connected to the supply lines 104 and is configured to inject a supplemental fluid into the supply lines 104 (e.g., chemigation). The supplemental fluid may be a nutrient, an exudation solution, and so forth. Additionally, the fluid displacement device 106 (e.g., a circulating pump) may be utilized in conjunction with the injection fluid displacement device 108 to circulate the fluid (and allow for a greater uniform distribution of the nutrients). The injection fluid displacement device 108 may be connected to a control device 110 that is configured to generate an on-demand injection of the nutrients. For example, the control device 110 is configured to determine when an amount of applicant that has been removed from the system 100 (e.g., applicant has been furnished to the plant roots on-demand). Once the control device 110 determines a predetermined amount of applicant that has been removed from the system 100 (e.g., the control device determines the aqueous solution is below an aqueous solution threshold), the control device 110 causes the injection fluid displacement device 108 (e.g., an on-demand injection device) to inject nutrients and/or the applicant into the supply lines 104 to replenish applicant within the system 100. In some implementations, the aqueous solution comprises a nutrient solution. In these implementations, the control device 110 comprises a sensor with means for detecting chlorophyll. In some implementations, the control device 110 comprising the sensor with means for detecting chlorophyll determines amount and timing intervals for application of nitrogen. The control device 110 may also be in communication with the fluid displacement devices 106 and configured to cause the fluid displacement devices 106 to displace the applicant at predetermined time intervals. In a specific implementation, the control device 110 is unitary with the reservoir 102. However, it is understood that the control device 110 may be separate from or replace the reservoir in other configurations (see FIG. 2).

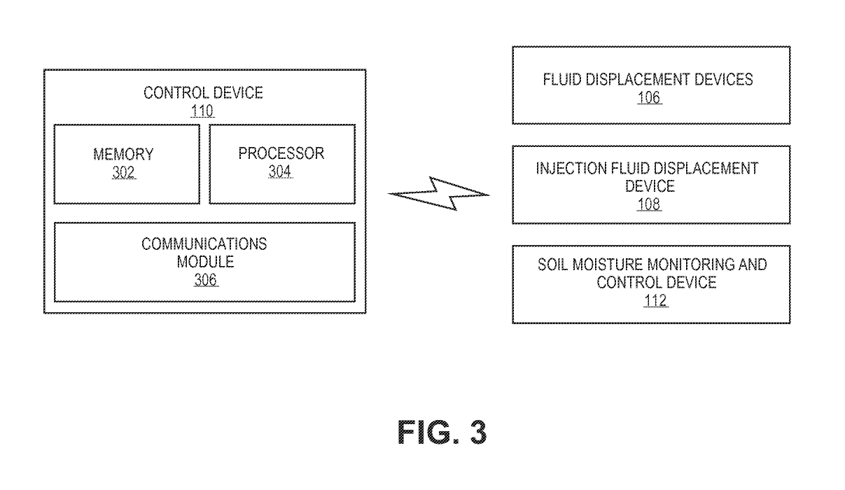

As shown in FIG. 3, the control device 110 the control device 110 includes a memory 302 to store one or more software programs (e.g., software modules), a processor 304 communicatively coupled to the memory 302, and a communications module 306 (e.g., transmitter, receiver, transceiver, etc.). The memory 302 is an example of tangible computer-readable media that provides storage functionality to store various data associated with the operation of the control device 110, such as software programs/modules and code segments mentioned herein, or other data to instruct the processor 120 to perform the steps described within the present disclosure.

The control device 110 may be configured to cause the injection fluid displacement device 108 to inject an exudation solution into the applicant to decrease (e.g., breakdown) the surface tension of the applicant. For example, the exudation solution may be furnished to the applicant to decrease the surface tension of the applicant and modify the flow of the applicant to the vegetation within the cultivation area (e.g., field) 116. Thus, the flow of the applicant may be modified according to the requirements of the vegetation (e.g., particular stage within the life cycle of the vegetation).

As shown in FIG. 1, the irrigation system 100 may further include a soil moisture monitoring and control device 112. In an implementation, the soil moisture monitoring and control device 112 is configured to monitor an amount of moisture within the soil (e.g., soil moisture). The soil moisture monitoring and control device 112 is configured to furnish feedback to the control device 110 to control one or more aspects of the irrigation system 100. For example, the soil moisture monitoring and control device 112 may furnish the soil moisture value to the control device 110. For example, the control device 110 may cause the fluid displacement device 108 to inject fluid into the supply lines 104 based upon the soil moisture value (e.g., soil moisture value is below a soil moisture threshold value). In another example, the control device 110 may prevent the fluid displacement device 108 from injecting additional fluid into the supply lines based upon the soil moisture value (e.g., soil moisture value is above a soil moisture threshold value).

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An irrigation system comprising:
a reservoir configured to store and to supply an aqueous solution;
a control device operatively coupled to the reservoir to control supply of the aqueous solution; and
at least one semi-porous supply line in fluid communication with the reservoir, the at least one semi-porous supply line having a porosity characteristic configured to be altered when acted upon by a surfactant root exudate to permit a flow of the aqueous solution therethrough,
wherein the control device is configured to cause injection of the aqueous solution upon a determination that an amount of aqueous solution within the at least one semi-porous supply line is below an aqueous solution threshold.

2. The irrigation system as recited in claim 1, further comprising a pump coupled to the at least one semi-porous supply line and coupled to the control device, the pump configured to circulate the aqueous solution within the semi-porous supply line.

3. The irrigation system as recited in claim 1, further comprising an injection fluid displacement device coupled to the at least one semi-porous supply line and coupled to the control device, the injection fluid displacement device configured to inject a supplemental fluid into the at least one semi-porous supply line.

4. The irrigation system as recited in claim 3, wherein the supplemental fluid comprises an exudation solution.

5. The irrigation system as recited in claim 3, wherein the supplement fluid comprises a nutrient.

6. The irrigation system as recited in claim 1, further comprising a soil moisture monitoring device configured to monitor soil moisture and provide feedback indicative of the soil moisture to the control device, wherein the control device is configured to cause injection of the aqueous solution when the feedback indicates the soil moisture is below a soil moisture threshold.

7. The irrigation system as recited in claim 6, wherein the control device is configured to prevent injection of the aqueous solution when the feedback indicates the soil moisture is above a soil moisture threshold.

8. An irrigation system comprising:
a reservoir configured to store and to supply an aqueous solution;
a control device operatively coupled to the reservoir to control supply of the aqueous solution; and
a plurality of semi-porous supply lines in fluid communication with the reservoir, the plurality of semi-porous supply lines having a porosity characteristic configured to be altered when acted upon by a surfactant root exudate to permit a flow of the aqueous solution therethrough,
wherein the control device is configured to cause injection of the aqueous solution from the reservoir upon a determination that an amount of aqueous solution within the plurality of semi-porous supply lines is below an aqueous solution threshold.

9. The irrigation system as recited in claim 8, further comprising a pump coupled to the plurality of semi-porous supply lines and coupled to the control device, the pump configured to circulate the aqueous solution within the plurality of semi-porous supply lines.

10. The irrigation system as recited in claim 8, further comprising an injection fluid displacement device coupled to the plurality of semi-porous supply lines and coupled to the control device, the injection fluid displacement device configured to inject a supplemental fluid into the plurality of semi-porous supply lines.

11. The irrigation system as recited in claim 10, wherein the supplemental fluid comprises an exudation solution.

12. The irrigation system as recited in claim 10, wherein the supplement fluid comprises a nutrient.

13. The irrigation system as recited in claim 8, further comprising a soil moisture monitoring device configured to monitor soil moisture and provide feedback indicative of the soil moisture to the control device, wherein the control device is configured to cause injection of the aqueous solution when the feedback indicates the soil moisture is below a soil moisture threshold.

14. The irrigation system as recited in claim 13, wherein the control device is configured to prevent injection of the aqueous solution when the feedback indicates the soil moisture is above a soil moisture threshold.

15. An irrigation system comprising:
a control device configured to control supply of an aqueous solution;
a plurality of semi-porous supply lines operatively coupled to the control device, the plurality of semi-porous supply lines having a porosity characteristic configured to be altered when acted upon by a surfactant root exudate to permit a flow of the aqueous solution therethrough;
an injection fluid displacement device coupled to the plurality of semi-porous supply lines and coupled to the control device, the injection fluid displacement device configured to inject a supplemental fluid into the plurality of semi-porous supply lines,
wherein the control device is configured to cause injection of the aqueous solution upon a determination that an amount of aqueous solution within the plurality of semi-porous supply lines is below an aqueous solution threshold.

16. The irrigation system as recited in claim 15, further comprising a pump coupled to the plurality of semi-porous supply lines and coupled to the control device, the pump configured to circulate the aqueous solution within the plurality of semi-porous supply lines.

17. The irrigation system as recited in claim 15, further comprising a pump coupled to the plurality of semi-porous supply lines and coupled to the control device, the pump configured to circulate the aqueous solution within the plurality of semi-porous supply lines.

18. The irrigation system as recited in claim 15, wherein the supplemental fluid comprises an exudation solution.

19. The irrigation system as recited in claim 15, wherein the supplement fluid comprises a nutrient.

20. The irrigation system as recited in claim 15, further comprising a soil moisture monitoring device configured to monitor soil moisture and provide feedback indicative of the soil moisture to the control device, wherein the control device is configured to cause injection of the aqueous solution when the feedback indicates the soil moisture is below a soil moisture threshold.
